(19) United States
(12) Patent Application Publication
(10) Pub. No.: US 2018/0228155 A1
(43) Pub. Date: Aug. 16, 2018

(54) Use of the succinate dehydrogenase inhibitor Fluopyram for controlling blackleg in Brassicaceae species

(71) Applicant: Bayer CropScience Aktiengesellschaft, Monheim am Rhein (DE)

(72) Inventors: Geoffrey Raymond ROBERTSON, Victoria (AU); Michael Gray ROUCH, Victoria (AU)

(21) Appl. No.: 15/745,863

(22) PCT Filed: Jul. 19, 2016
(86) PCT No.: PCT/EP2016/067104

§ 371 Date: Jan. 18, 2018

(30) Foreign Application Priority Data
Jul. 20, 2015 (EP) 15177588.9

(51) Int. Cl. A01N 43/40

(52) U.S. Cl. CPC A01N 43/40

(57) ABSTRACT

The invention relates to the use of the succinate dehydrogenase inhibitor Fluopyram, for controlling Leptosphaeria maculans in Brassicaceae plants, plant parts thereof, plant propagation material or the soil in which Brassicaceae plants are grown or intended to be grown, to a method for treating plants or plant parts for controlling Leptosphaeria maculans and to a method for treating seed for controlling Leptosphaeria maculans in the seed and in the plants which grow from the seed, by treating the seed with the succinate dehydrogenase inhibitor Fluopyram.

The invention relates to the use of the succinate dehydrogenase inhibitor Fluopyram for controlling blackleg caused by Leptosphaeria maculans in Brassicaceae plants, to a method for treating Brassicaceae plants, plant parts thereof, plant propagation material or the soil in which Brassicaceae plants are grown or intended to be grown for controlling Leptosphaeria maculans and to a method for controlling Leptosphaeria maculans in Brassicaceae seed and in Brassicaceae plants which grow from the seed, by treating the Brassicaceae seed with Fluopyram.

Blackleg in Brassicaceae plants, caused by Leptosphaeria maculans, is the most economically important disease of canola (Brassica napus) in Australia and can cause significant loss of yield, especially for susceptible varieties grown in the higher rainfall areas. Canola can be infected by Leptosphaeria maculans at any growth stage but the most damage is done from early infection where the disease infects the cotyledons and/or early leaves causing lesions on the cotyledons and leaves. The disease grows down the plants vascular tissue, eventually causing the characteristic stem canker at the base of the plant or ‘black leg’. The stem canker restricts the supply of moisture to the plant and seed set is reduced. In some cases the stem canker causes the plant to lodge prior to crop harvest. Blackleg in canola is managed by a combination of strategies which include the current standard fungicide seed treatment of fluquinconazole, fungicide treatments to fertiliser which is drilled in the crop row at the same time as seeding, sowing canola varieties that have genetic resistance to the disease, sowing canola at least 500 metres from the previous season's canola stubble (the main source of inoculum) and the application of foliar fungicides to crop at high risk of developing disease.

Leptosphaeria maculans is of great economic significance in Brassicaceae plant species, in particular in winter and spring oilseed rape and Canola.

There is therefore an urgent need for fungicides which enable sufficient control Leptosphaeria maculans, in Brassicaceae plants, for example oilseed rape. Leptosphaeria maculans is more preferably to be controlled in Canola.

WO 2004/16088 discloses derivatives of the pyridinylethylbenzamide fungicides, for example Fluopyram (Example 20), which are utilized against different fungi. However, it is not apparent from the teaching of the publication which specific pyridinylethylbenzamide fungicides are suitable for treatment of Leptosphaeria maculans. Fluopyram is known mainly as a foliar fungicide for fruits and vegetables under the brand-name Luna™ sold by Bayer Crop Science (http://www.cropscience.bayer.com/Products-and-Innovation/Brands/Fungicides.aspx). EP-A 2 100 506 discloses the use of Fluopyram against Leptosphaeria maculans in oilseed rape but discloses no further details about efficacy or preferred methods how to treat oilseed rape affected. WO-A 2010/139410 describes the activity of Fluopyram against Sclerotinia spp. in soybean and oilseed rape. WO 2010/086103 describes the activity of Fluopyram against powdery mildew primary infection. More particularly, all documents do not explicitly disclose the suitability of Fluopyram for treatment of Leptosphaeria maculans, in particular using seed treatment methods.

It has now been found that, surprisingly, the succinate dehydrogenase inhibitor Fluopyram is particularly suitable for control of Leptosphaeria maculans in Brassicaceae plants, plant parts thereof, plant propagation material or the soil in which Brassicaceae plants are grown or intended to be grown, in particular in winter and spring oilseed rape or Canola. It has also been found that the use of Fluopyram, in the presence of blackleg disease and in plants with known susceptibility to blackleg disease, increases yield of Brassicaceae plants. In another embodiment the use of Fluopyram controls the infection in early leaves of Brassicaceae plants, the stem infection in Brassicaceae plants and reduces lodging of Brassicaceae plants. In addition, Fluopyram offers a different mode of action for controlling blackleg being a succinate dehydrogenase inhibitor than the current market standard Fluquinconazole being a sterol biosynthesis inhibitor.

The use of Fluopyram for control of Leptosphaeria maculans in Canola has been found to be particularly advantageous.

In an alternative embodiment of the invention, combinations comprising Fluopyram and a further fungicide can be used for control of Leptosphaeria maculans in Brassicaceae plants.

The present invention accordingly provides for the use of the succinate dehydrogenase inhibitor Fluopyram for control of Leptosphaeria maculans. In another embodiment the use of the succinate dehydrogenase inhibitor Fluopyram in seed treatment methods for control of Leptosphaeria maculans is described.

Fluopyram, which has the chemical name N-{[3-chloro-5-(trifluoromethyl)-2-pyridinyl]ethyl}-2-trifluoromethylbenzamide, and suitable processes for preparation thereof, proceeding from commercially available starting materials, are described in WO 2004/16088.

In the context of the present invention, “control of Leptosphaeria maculans” means a significant reduction in infestation by Leptosphaeria maculans, compared with the untreated plant, preferably a significant reduction (by 40-79%), compared with the untreated plant (0% infection reduction); more preferably, the infection by Leptosphaeria maculans is entirely suppressed (by 70-100%). The control may be curative, i.e. for treatment of already infected plants, or protective, for protection of plants which have not yet been infected.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

In the context of the present invention, “lodging” refers to the bending or falling over of the stem of the Brassicaceae plants. It can be measured for example as the degree of lean to the lower stem of a plant or by visual assessment of plants in an area.

### Uses

The treatment of the plants and plant parts with Fluopyram or compositions comprising Fluopyram is carried out directly or by acting on the environment, habitat or storage space using customary treatment methods, for example by dipping, spraying, atomizing, misting, evaporating, dusting, fogging, scattering, foaming, painting on, spreading, injecting, drenching, trickle irrigation and, in the case of propagation material, in particular in the case of seed, furthermore by the dry seed treatment method, the wet seed treatment method, the slurry treatment method, by encrusting, by coating with one or more coats and the like. It is furthermore possible to apply the active substances by the ultra-low volume method or to inject the active substance preparation or the active substance itself into the soil.

A preferred direct treatment of the plants is the leaf application treatment, i.e. Fluopyram or compositions comprising Fluopyram are applied to the foliage, it being possible for the treatment frequency and the application rate to be matched to the infection pressure of the Leptosphaeria maculans in question.

In the case of systemically active compounds, Fluopyram or compositions comprising Fluopyram reach the plants via the root system. In this case, the treatment of the plants is effected by allowing Fluopyram or compositions comprising Fluopyram to act on the environment of the plant. This can be done for example by drenching, incorporating in the soil or into the nutrient solution, i.e. the location of the plant (for example the soil or hydroponic systems) is impregnated with a liquid form of Fluopyram or compositions comprising Fluopyram, or by soil application, i.e. the Fluopyram or compositions comprising Fluopyram are incorporated into the location of the plants in solid form (for example in the form of granules).

More particularly, the inventive use exhibits the advantages described on Brassicaceae plants, plant parts thereof, plant propagation material or the soil in which Brassicaceae plants are grown or intended to be grown in spray application, in seed treatment, in drip and drench applications, in-furrow application, chemigation, i.e. by addition of Fluopyram to the irrigation water, and in hydroponic/mineral systems.

Combinations of Fluopyram, with substances including insecticides, fungicides and bactericides, fertilizers, growth regulators, can likewise find use in the control of plant diseases in the context of the present invention. The combined use of Fluopyram, with genetically modified cultivars, especially of transgenic oilseed rape cultivars, is additionally likewise possible.

The use of Fluopyram is effected preferably with a dosage between 0.01 and 3 kg/ha, more preferably between 0.05 and 2 kg/ha, very preferably between 0.1 and 1 kg/ha, most preferably between 0.1 and 1 kg/ha.

In one embodiment the use of Fluopyram is effected preferably for in-furrow application with a dosage between 0.005 and 500 g/ha, between 0.01 and 250 kg/ha 0.02 and 100 g/ha, between 1 and 80 g/ha, between 5 and 80 g/ha, between 10 and 50 g/ha, or between 0.02 and 0.05 g/ha.

### Formulations

In one embodiment fungicidal compositions comprising Fluopyram are described which further comprise agriculturally suitable auxiliaries, solvents, carriers, surfactants or extenders.

According to the invention, a carrier is a natural or synthetic, organic or inorganic substance with which the active ingredients are mixed or combined for better applicability, in particular for application to plants or plant parts or seed. The carrier, which may be solid or liquid, is generally inert and should be suitable for use in agriculture.

Useful solid carriers include: for example ammonium salts and natural rock flours, such as kaolins, clays, talc, chalk, quartz, attapulgite, montmorillonite or diatomaceous earth, and synthetic rock flours, such as finely divided silica, alumina and silicates; useful solid carriers for granules include: for example, crushed and fractionated natural rocks such as calcite, marble, pumice, sepiolite and dolomite, and also synthetic granules of inorganic and organic flours, and granules of organic material such as paper, sawdust, coconut shells, maize cobs and tobacco stalks; useful emulsifiers and/or foam-formers include: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Additionally suitable are oligo- or polymers, for example those derived from vinylic monomers, from acrylic acid, from EO and/or PO alone or in combination with, for example, (poly)alcohols or (poly)amines. It is also possible to use lignin and its sulphonic acid derivatives, unmodified and modified celluloses, aromatic and/or aliphatic sulphonic acids and also their adducts with formaldehyde.

Fluopyram can be converted to the customary formulations, such as solutions, emulsions, wettable powders, water- and oil-based suspensions, powders, dusts, pastes, soluble powders, soluble granules, granules for broadcasting, suspoemulsion concentrates, natural products impregnated with active ingredient, synthetic substances impregnated with active ingredient, fertilizers and also microencapsulations in polymeric substances.

Fluopyram can be applied as such, in the form of its formulations or the use forms prepared therefrom, such as ready-to-use solutions, emulsions, water- or oil-based suspensions, powders, wettable powders, pastes, soluble powders, dusts, soluble granules, granules for broadcasting, suspoemulsion concentrates, natural products impregnated with active ingredient, synthetic substances impregnated with active ingredient, fertilizers and also microencapsulations in polymeric substances. Application is accomplished in a customary manner, for example by watering, spraying, atomizing, broadcasting, dusting, foaming, spreading-on and the like. It is also possible to deploy the active ingredients by the ultra-low volume method or to inject the active ingredient preparation/the active ingredient itself into the soil. It is also possible to treat the seed of the plants.

The formulations mentioned can be prepared in a manner known per se, for example by mixing the active ingredients with at least one customary extender, solvent or diluent, emulsifier, dispersant and/or binder or fixing agent, wetting agent, a water repellent, if appropriate siccatives and UV stabilizers and if appropriate dyes and pigments, antifoams, preservatives, secondary thickeners, stickers, gibberellins and also other processing auxiliaries.

The present invention includes not only formulations which are already ready for use and can be deployed with a suitable apparatus to the plant or the seed, but also commercial concentrates which have to be diluted with water prior to use.

Fluopyram may be present as such or in its (commercial) formulations and in the use forms prepared from these formulations as a mixture with other (known) active ingredients, such as insecticides, attractants, sterilants, bactericides, acaricides, nematicides, fungicides, growth regulators, herbicides, fertilizers, safeners and/or semiochemicals.

The auxiliaries used may be those substances which are suitable for imparting particular properties to the composition itself or and/or to preparations derived therefrom (for example spray liquors, seed dressings), such as certain technical properties and/or also particular biological properties. Typical auxiliaries include: extenders, solvents and carriers.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which may optionally also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

Liquefied gaseous extenders or carriers are understood to mean liquids which are gaseous at standard temperature and under standard pressure, for example aerosol propellants such as halohydrocarbons, or else butane, propane, nitrogen and carbon dioxide.

In the formulations it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

If the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Compositions comprising Fluopyram may additionally comprise further components, for example surfactants. Suitable surfactants are emulsifiers and/or foam formers, dispersants or wetting agents having ionic or nonionic properties, or mixtures of these surfactants. Examples thereof are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example alkylaryl polyglycol ethers, alkylsulphonates, alkyl sulphates, arylsulphonates, protein hydrolysates, lignosulphite waste liquors and methylcellulose. The presence of a surfactant is necessary if one of the active ingredients and/or one of the inert carriers is insoluble in water and when application is effected in water. The proportion of surfactants is between 5 and 40 percent by weight of the inventive composition.

It is possible to use dyes such as inorganic pigments, for example iron oxide, titanium oxide and Prussian Blue, and organic dyes such as alizarin dyes, azo dyes and metal phthalocyanine dyes, and trace nutrients such as salts of iron, manganese, boron, copper, cobalt, molybdenum and zinc.

Further additives may be perfumes, mineral or vegetable, optionally modified oils, waxes and nutrients (including trace nutrients), such as salts of iron, manganese, boron, copper, cobalt, molybdenum and zinc.

Additional components may be stabilizers, such as cold stabilizers, preservatives, antioxidants, light stabilizers, or other agents which improve chemical and/or physical stability.

If appropriate, other additional components may also be present, for example protective colloids, binders, adhesives, thickeners, thixotropic substances, penetrants, stabilizers, sequestering agents, complex formers. In general, the active ingredients can be combined with any solid or liquid additive commonly used for formulation purposes.

The formulations contain generally between 0.05 and 99% by weight, 0.01 and 98% by weight, preferably between 0.1 and 95% by weight, more preferably between 0.5 and 90% of active ingredient, most preferably between 10 and 70 percent by weight.

In one embodiment formulations of Fluopyram comprise 300 to 700 g/L Fluopyram as an SC or FS formulation, preferably 380 to 600 g/L Fluopyram.

In one embodiment formulations of Fluopyram comprise in addition one or more dyes or pigments.

The formulations described above can be used for control of Leptosphaeria maculans, in which the compositions comprising Fluopyram are applied to Leptosphaeria maculans and/or in their habitat.

### Plants

According to the invention all plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners, slips and seeds also belong to plant parts.

In one embodiment crop plants belonging to the plant family Brassicaceae are Brassica plants.

In a preferred embodiment crop species, cultivars and varieties belonging to the plant genus Brassica are
Brassica carinata: Abyssinian mustard or Abyssinian cabbage
Brassica elongata: elongated mustard
Brassica fruticulosa: Mediterranean cabbage
Brassica juncea: Indian mustard, brown and leaf mustards, Sarepta mustard
Brassica napus comprising winter rapeseed, spring rapeseed, rutabaga (Brassica napus subsp rapifera swede/Swedish turnip/swede turnip)
Brassica narinosa: broadbeaked mustard
Brassica nigra: black mustard
Brassica oleracea comprising cultivars like kale, cabbage, broccoli, cauliflower, kai-lan, Brussels sprouts, kohlrabi
Brassica perviridis: tender green, mustard spinach
Brassica rapa (syn B. campestris) comprising Chinese cabbage, turnip, rapini, komatsuna
Brassica rupestris: brown mustard
Brassica septiceps: seventop turnip
Brassica tournefortii: Asian mustard
Brassica alba (syn Sinapis alba, white mustard)
Canola varieties

To use the name canola, an oilseed plant must meet the following internationally regulated standard:

“Seeds of the genus Brassica (Brassica napus, Brassica rapa or Brassica juncea) from which the oil shall contain less than 2% erucic acid in its fatty acid profile and the solid component shall contain less than 30 micromoles of any one or any mixture of 3-butenyl glucosinolate, 4-pentenyl glucosinolate, 2-hydroxy-3 butenyl glucosinolate, and 2-hydroxy-4-pentenyl glucosinolate per gram of air-thy, oil-free solid.”

Further preferred crop plants belonging to the plant family Brassicaceae are horseradish (Armoracia rusticana), radish (e.g. Raphanus sativus var. oleiformis, Raphanus sativus L. var. sativus.

More preferred Brassica plants, plant parts or seeds according to the present invention are oilseed rape plants, plant parts or seeds (Brassica napus), Canola plants, plant parts or seeds or Brassica juncea plants, plant parts or seeds; more preferred winter oilseed rape plants, plant parts or seeds (Brassica napus), spring oilseed rape plants, plant parts or seeds or Canola, plant parts or seeds.

In one aspect Brassica napus or juncea plants, plant parts or seeds are hybrid plants, plant parts or seeds. In another aspect Brassica napus or juncea hybrids are Ogura hybrids, Ms8/Rf3 hybrids (marketed under the tradename Invigor) or Ms11/Rf3 hybrids.

In another embodiment the Brassica napus or juncea plants, plant parts or seeds are tolerant to one or more of the herbicides selected from the group of glufosinate, glyphosate (tradename RoundupReady), imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-ammonium, atrazine, simazine.

The term “growth stage” refers to the growth stages as defined by the BBCH Codes in “Growth stages of mono- and dicotyledonous plants”, 2nd edition 2001, edited by Uwe Meier from the Federal Biological Research Centre for Agriculture and Forestry. The BBCH codes are a well-established system for a uniform coding of phonologically similar growth stages of all mono- and dicotyledonous plant species. The abbreviation BBCH derives from “Biologische Bundesanstalt, Bundessortenamt and Chemische Industrie”.

Some of these BBCH growth stages and BBCH codes for oilseed rape plants are indicated in the following.
Growth stage 1: Leaf development1
BBCH 10—Cotyledons completely unfolded
BBCH 11—First leaf unfolded
BBCH 12—2nd leaf unfolded
BBCH 13—3rd leaf unfolded
BBCH 14-18 Stages continuous till . . . (4-8th leaf unfolded)
BBCH 19-9 or more leaves unfolded
Growth stage 2: Formation of side shoots
BBCH 20—No side shoots
BBCH 21—Beginning of side shoot development: first side shoot detectable
BBCH 22—2nd side shoots detectable
BBCH 23—3rd side shoots detectable
BBCH 24—4th side shoots detectable
BBCH 25—5th side shoots detectable
BBCH 26-28—Stages continuous till . . . (6-8 side shoots detectable)
BBCH 29 End of side shoot development: 9 or more side shoots detectable
Growth stage 3: Stem elongation2
BBCH 30—Beginning of stem elongation: no internodes (“rosette”)
BBCH 31—1 visibly extended internode
BBCH 32—2nd visibly extended internode
BBCH 33—3rd visibly extended internode
. . .
BBCH 39—9 or more visibly extended internodes
. . .
Growth stage 8: Ripening
BBCH 80—Beginning of ripening: seed green, filling pod cavity
BBCH 81-10% of pods ripe, seeds dark and hard
BBCH 82-20% of pods ripe, seeds dark and hard
BBCH 83-30% of pods ripe, seeds dark and hard
BBCH 84-40% of pods ripe, seeds dark and hard
BBCH 85-50% of pods ripe, seeds dark and hard
BBCH 86-60% of pods ripe, seeds dark and hard
BBCH 87-70% of pods ripe, seeds dark and hard
BBCH 88-80% of pods ripe, seeds dark and hard
BBCH 89—Fully ripe: nearly all pods ripe, seeds dark and hard
Growth stage 9: Senescence
BBCH 97—Plant dead and dry
BBCH 99—Harvested product

Particular preference is given in accordance with the invention to treating plants of the plant cultivars which are each commercially available or in use. Plant cultivars are understood to mean plants which have new properties (“traits”) and which have been obtained by conventional breeding, by mutagenesis or with the aid of recombinant DNA techniques. Crop plants may accordingly be plants which can be obtained by conventional breeding and optimization methods or by biotechnology and genetic engineering methods or combinations of these methods, including the transgenic plants and including the plant varieties which can and cannot be protected by plant variety rights.

The method according to the invention can thus also be used for the treatment of genetically modified organisms (GMOs), for example plants or seeds. Genetically modified plants (or transgenic plants) are plants in which a heterologous gene has been integrated stably into the genome. The term “heterologous gene” means essentially a gene which is provided or assembled outside the plant and which, on introduction into the cell nucleus genome, imparts new or improved agronomic or other properties to the chloroplast genome or the mitochondrial genome of the transformed plant by virtue of it expressing a protein or polypeptide of interest or by virtue of another gene which is present in the plant, or other genes which are present in the plant, being downregulated or silenced (for example by means of antisense technology, co-suppression technology or RNAi technology [RNA interference]). A heterologous gene present in the genome is likewise referred to as a transgene. A transgene which is defined by its specific presence in the plant genome is referred to as a transformation or transgenic event.

Plants and plant cultivars which are preferably treated according to the invention include all plants which have genetic material which imparts particularly advantageous, useful traits to these plants (whether obtained by breeding and/or biotechnological means).

Plants and plant cultivars which may also be treated in according to invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients or shade avoidance.

Plants and plant cultivars which may also be treated according to the invention are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may also be treated according to the invention are hybrid plants that already express the characteristic of heterosis or hybrid vigour which generally results in higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in maize) be produced by detasseling, i.e. the mechanical removal of the male reproductive organs (or male flowers), but, more typically, male sterility is the result of genetic determinants in the plant genome. In that case, and especially when seed is the desired product to be harvested from the hybrid plants, it is typically useful to ensure that male fertility in hybrid plants that contain the genetic determinants responsible for the male sterility is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmatic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396, in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may likewise be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants that have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species). Plants expressing an exogenous phosphinothricin acetyltransferase are for example described in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that have been made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally occurring resistant HPPD enzyme, or a gene encoding a mutated HPPD enzyme according to WO 1996/038567, WO 1999/024585 and WO 1999/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS-inhibitors include, for example, sulphonylurea, imidazolinone, triazolopyrimidines, pyrimidinyloxy(thio)benzoates, and/or sulphonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also in U.S. Pat. No. 5,605,011, U.S. Pat. No. 5,378,824, U.S. Pat. No. 5,141,870 and U.S. Pat. No. 5,013,659. The production of sulphonylurea-tolerant plants and imidazolinone-tolerant plants is described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and international publication WO 1996/033270. Other imidazolinone-tolerant plants are also described in for example WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants are also described in for example WO 2007/024782.

Other plants tolerant to imidazolinone and/or sulphonylurea can be obtained by induced mutagenesis, selection in cell cultures in the presence of the herbicide or by mutation breeding as described for example for soya beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

The term “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) in the Bacillus thuringiensis toxin nomenclature, online at:
   http://www.lifesci.sussex.ac.uk/Home/Neil_Crickmore/Bt/), or insecticidal portions thereof, e.g. proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm. Microb. (2006), 71, 1765-1774); or
3) a hybrid insecticidal protein comprising parts of two different insecticidal crystal proteins from Bacillus thuringiensis, such as a hybrid of the proteins of 1) above or a hybrid of the proteins of 2) above, e.g. the Cry1A.105 protein produced by maize event MON98034 (WO 2007/027777); or
4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR604; or
5) an insecticidal secreted protein from Bacillus thuringiensis or Bacillus cereus, or an insecticidal portion thereof, such as the vegetative insecticidal proteins (VIP) listed at: http://www.lifesci.sussex.ac.uk/home/Neil_Crickmore/Bt/vip.html, e.g. proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT102.

Of course, insect-resistant transgenic plants, as used herein, also include any plant comprising a combination of genes encoding the proteins of any one of the abovementioned classes 1 to 8. In one embodiment, an insect-resistant plant contains more than one transgene encoding a protein of any one of the abovementioned classes 1 to 8, to expand the range of target insect species affected or to delay insect resistance development to the plants, by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include:
a. plants which contain a transgene capable of reducing the expression and/or the activity of the poly(ADP-ribose)polymerase (PARP) gene in the plant cells or plants as described in WO 2000/004173 or EP 04077984.5 or EP 06009836.5;
b. plants which contain a stress tolerance-enhancing transgene capable of reducing the expression and/or the activity of the PARG encoding genes of the plants or plant cells as described, for example, in WO 2004/090140;
c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyltransferase, nicotinamide adenine dinucleotide synthetase or nicotinamide phosphoribosyltransferase as described, for example, in EP 04077624.7 or WO 2006/133827 or PCT/EP07/002433.

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants containing a mutation imparting such altered oil characteristics and include:
a) plants, such as oilseed rape plants, producing oil having a high oleic acid content, as described, for example, in U.S. Pat. No. 5,969,169, U.S. Pat. No. 5,840,946 or U.S. Pat. No. 6,323,392 or U.S. Pat. No. 6,063,947;
b) plants, such as oilseed rape plants, producing oil having a low linolenic acid content, as described in U.S. Pat. No. 6,270,828, U.S. Pat. No. 6,169,190 or U.S. Pat. No. 5,965,755.
c) plants, such as oilseed rape plants, producing oil having a low level of saturated fatty acids, as described, for example, in U.S. Pat. No. 5,434,283.

The Brassica napus or Brassica juncea plants or cultivars are also understood to be hybrids. Of particular interest are spring or winter oilseed rape, especially Canola hybrids. These hybrids may have in addition new properties (“traits”), which may have been obtained by conventional biological breeding methods, such as crossing or protoplast fusion. In a further preferred embodiment, transgenic plants and plant cultivars of Brassicaceae are obtained by genetic engineering, if appropriate in combination with conventional methods

### (Genetically Modified Organisms).

Particularly useful transgenic Brassicaceae plants are plants containing transformation events, or a combination of transformation events, and that are listed for example in the databases for various national or regional regulatory agencies including Event BLR1 (oilseed rape, restoration of male sterility, deposited as NCIIVIB 41193, described in WO 2005/074671), Event MON88302 (oilseed rape, herbicide tolerance, deposited as PTA-10955, described in WO 2011/153186), Event MS11 (oilseed rape, pollination control—herbicide tolerance, deposited as ATCC PTA-850 or PTA-2485, described in WO 01/031042); Event MS8 (oilseed rape, pollination control—herbicide tolerance, deposited as ATCC PTA-730, described in WO 01/041558 or US-A 2003-188347); Event RF3 (oilseed rape, pollination control—herbicide tolerance, deposited as ATCC PTA-730, described in WO 01/041558 or US-A 2003-188347); Event RT73 (oilseed rape, herbicide tolerance, not deposited, described in WO 02/036831 or US-A 2008-070260), event MON-88302-9 (oilseed rape, herbicide tolerance, ATCC Accession No PTA-10955, WO 2011/153186A1), event DP-061061-7 (oilseed rape, herbicide tolerance, no deposit No available, WO 2012071039A1), event DP-073496-4 (oilseed rape, herbicide tolerance, no deposit No available, US2012131692).

### Seed Treatment

The treatment of the seed of plants has been known for a long time and is the subject of constant improvements. Nevertheless, the treatment of seed gives rise to a series of problems which cannot always be solved in a satisfactory manner. For instance, it is desirable to develop methods for protecting the seed, the germinating plant and the resulting plants or plant parts, which dispense with, or at least significantly reduce, the additional deployment of crop protection products after planting or after emergence of the plants. It is additionally desirable to optimize the amount of Fluopyram used in such a way as to provide the best possible protection for the seed and the germinating plant from attack by Leptosphaeria maculans, but without damaging the Brassicaceae plant itself by the active ingredient used.

The present invention therefore relates more particularly also to a method for treating seed to control Leptosphaeria maculans in Brassicaceae plants which grow from the seed or seedlings, by treating the Brassicaceae seed with Fluopyram.

In another embodiment a method for treating seed to control Leptosphaeria maculans in Brassicaceae plants at BBCH stage 10 or later which grow from the seed or seedlings, by treating the Brassicaceae seed at BBCH stage 00 with Fluopyram.

In another embodiment a method for treating seed to control Leptosphaeria maculans in Brassica napus plants at BBCH stage 10 or later which grow from the seed or seedlings, by treating the Brassica napus seed at BBCH stage 00 with Fluopyram.

In another embodiment a method for treating seed to control Leptosphaeria maculans in canola plants at BBCH stage 10 or later which grow from the seed or seedlings, by treating the canola seed at BBCH stage 00 with Fluopyram.

In another embodiment a method for treating seed to control Leptosphaeria maculans in canola hybrid plants at BBCH stage 10 or later which grow from the seed or seedlings, by treating the canola hybrid seed at BBCH stage 00 with Fluopyram.

In another embodiment a method for treating seed to control Leptosphaeria maculans in herbicide tolerant canola hybrid plants at BBCH stage 10 or later which grow from the seed or seedlings, by treating the herbicide tolerant canola hybrid seed at BBCH stage 00 with Fluopyram.

The invention likewise relates to the use of Fluopyram for treatment of seed to control Leptosphaeria maculans in the seed, the germinating plant and the plants or plant parts which grow therefrom.

One of the advantages of the present invention is that, owing to the particular systemic properties of Fluopyram, the treatment of the seed with Fluopyram, enables not only the control of Leptosphaeria maculans on the seed itself, but also on the plants which originate therefrom after emergence. In this way, the immediate treatment of the crop at the time of sowing or shortly thereafter can be dispensed with.

It is likewise considered to be advantageous that Fluopyram, can especially also be used in transgenic seed.

Fluopyram, is applied to the seed alone or in a suitable formulation Preferably, the seed is treated in a state in which it is stable enough to avoid damage during treatment. In general, the seed may be treated at any time between harvest and sowing. The seed typically used has been separated from the plant and freed from cobs, shells, stalks, coats, hairs or the fruit flesh. For example, it is possible to use seed which has been harvested, cleaned and dried to a moisture content of less than 15% by weight. Alternatively, it is also possible to use seed which, after drying, for example, has been treated with water and then dried again.

When treating the seed, it must generally be ensured that the amount of Fluopyram applied to the seed and/or of further additives is selected such that the germination of the seed is not impaired, and that the resulting plant is not damaged. This should be noted in particular in the case of active ingredients which can have phytotoxic effects at particular application rates.

Fluopyram can be applied directly, i.e. without containing any further components and without having been diluted. In general, it is preferable to apply Fluopyram, to the seed in the form of a suitable formulation.

Suitable formulations and methods for seed treatment are known to those skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

Fluopyram can be converted to the customary seed dressing formulations, such as solutions, emulsions, suspensions, powders, foams, slurries or other coating materials for seed, and also ULV formulations.

These formulations are produced in a known manner, by mixing the active ingredients or active ingredient combinations with customary additives, for example customary extenders and solvents or diluents, dyes, wetting agents, dispersants, emulsifiers, defoamers, preservatives, secondary thickeners, stickers, gibberellins and also water.

Useful dyes which may be present in the seed dressing formulations usable in accordance with the invention are all dyes customary for such purposes. It is possible to use both sparingly water-soluble pigments and water-soluble dyes. Examples include the dyes known under the Rhodamine B, C.I. Pigment Red 112 and C.I. Solvent Red 1 names.

The wetting agents which may be present in the seed dressing formulations usable in accordance with the invention include all substances which promote wetting and are customary for formulation of active agrochemical ingredients. Usable with preference are alkyl naphthalenesulphonates, such as diisopropyl or diisobutyl naphthalenesulphonate.

The dispersants and/or emulsifiers which may be present in the seed dressing formulations usable in accordance with the invention include all nonionic, anionic and cationic disperants which are customary for formulation of active agrochemical ingredients. Usable with preference are nonionic or anionic dispersants or mixtures of nonionic or anionic dispersants. Suitable nonionic dispersants include especially ethylene oxide-propylene oxide block polymers, alkylphenol polyglycol ethers and tristyrylphenol polyglycol ethers, and the phosphated or sulphated derivatives thereof. Suitable anionic dispersants are especially lignosulphonates, polyacrylic acid salts and arylsulphonate-formaldehyde condensates.

The defoamers which may be present in the seed dressing formulations usable in accordance with the invention include all foam-inhibiting substances customary for formulation of active agrochemical ingredients. Usable with preference are silicone defoamers and magnesium stearate.

The preservatives which may be present in the seed dressing formulations usable in accordance with the invention include all substances usable for such purposes in agrochemical formulations. Examples include dichlorophene and benzyl alcohol hemiformal.

Useful secondary thickeners which may be present in the seed dressing formulations usable in accordance with the invention include all substances usable for such purposes in agrochemical formulations. Preferred examples include cellulose derivatives, acrylic acid derivatives, xanthan, modified clays and finely divided silica.

Useful stickers which may be present in the seed dressing formulations usable in accordance with the invention are all customary binders usable in seed dressing compositions. Preferred examples include polyvinylpyrrolidone, polyvinyl acetate, polyvinyl alcohol and tylose.

The gibberellins which may be present in the seed dressing formulations usable in accordance with the invention are preferably gibberellins A1, A3 (=gibberellic acid), A4 and A7, particular preference being given to using gibberellic acid. The gibberellins are known (cf. R. Wegler “Chemie der Pflanzenschutz- and Schädlingsbekämpfungsmittel” [Chemistry of Crop Protection and Pest Control Compositions], vol. 2, Springer Verlag, 1970, p. 401-412).

The seed dressing formulations usable in accordance with the invention can be used to treat either directly or after preceding dilution with water. The seed dressing preparations usable in accordance with the invention or the dilute preparations thereof can also be used to dress seed of transgenic plants. In this case, it is also possible for additional synergistic effects to occur in interaction with substances formed by expression.

For treatment of seed with the seed dressing formulations usable in accordance with the invention, or the preparations prepared therefrom by adding water, all mixing units usable customarily for the seed dressing are useful. Specifically, the seed dressing procedure is to introduce the seed into a mixer, to add the particular desired amount of seed dressing formulations, either as such or after preceding dilution with water, and to mix until the formulation is distributed homogeneously on the seed. This may be followed by a drying operation.

The application rate of seed dressing formulations usable in accordance with the invention may vary within a relatively wide range. It is guided by the particular content of the active ingredients in the formulations and by the seed. The application rates of seed treatment compositions comprising Fluopyram are generally between 0.1 and 5000 g per 100 kilogram of seed, preferably between 50 and 1000 g per 100 kilogram of seed, more preferably between 100 and 500 g per 100 kilogram of seed, most preferably between 150 and 400 g per kilogram of seed.

Fluopyram, may be present in their commercially available formulations and in the use forms, prepared from these formulations, as a mixture with other active ingredients, such as insecticides, attractants, sterilants, bactericides, acaricides, nematicides, fungicides, growth regulators, herbicides, safeners, fertilizers or semiochemicals.

In another embodiment Fluopyram may be present in their commercially available formulations and in the use forms, prepared from these formulations, as a mixture with one or more active ingredients selected from the group of prothioconazole, tebuconazole, epoxiconazole, difenoconazole, fluquinconazole, flutriafol, azoxystrobin, trifloxystrobin, fluoxastrobin, fludioxonil, metalaxyl, mefenoxam, pyraclostrobin, pyrimethanil, chlorothalonil, spiroxamine, bixafen, penflufen, fluxapyroxad, boscalid, benzovindiflupyr, sedaxane, isopyrazam, metalaxyl, metrafenone, imidacloprid, clothianidin, thiacloprid, thiamethoxam, rynaxapyr, cyazypyr, spirotetramate, spiromesifen, tetraniliprole, flubendiamide, cyclaniliprole, lambda-cyhalothrin,

The example which follows serves to illustrate the invention, but without restricting it.

### EXAMPLE 1

In Australia, in 2014, a test plot was conducted with the canola variety ATR Cobbler, which was classed as MS-S (Moderately susceptible to susceptible for bare seed) by the 2012 Australian National Blackleg Rating scheme, sown in a field next to canola stubble in a high rainfall area of the canola growing area of Southern New South Wales, to evaluate the efficacy of fluopyram as a seed treatment for the control of blackleg. Fluopyram 600 FS (600 g/L fluopyram) was applied at 280, 420 and 560 mL/100 kg canola seed using a liquid batch seed treater with a slurry volume of 1000 mL/100 kg seed. The resulting application rates were 168 g/100 kg seeds, 252 g/100 kg seeds, 336 g/100 kg seeds. For comparison Jockey Stayer (167 g/L fluquinconazole) was applied, undiluted, at the current registered rate of 2 L/100 kg seed. Fluopyram 600 FS at 420 and 560 mL/100 kg gave comparable levels of protection of cotyledons, reduction in lodging, reduction in stem disease severity and yield response as Jockey Stayer at 2 L/100 kg (Table 1).

TABLE 1
Efficacy of fluopyram against Leptosphaeria maculans
in canola (var. ATR Cobbler)

| Protocol/Trial | | | | | |
|---|---|---|---|---|---|
| Crop | | Brassica napus canola | | | |
| Target | | Leptosphaeria maculans | | | |
| Part Rated | | Cotyledon | Plant | Stem | Grain |
| Days after Planting | | 43 | 157 | 158 | 185 |
| | | % Leaf Area | % Plants | % Stem Area | Yield |
| Entry Description | Dosage | Infected | Lodged | Infected | (t/ha) |
| Untreated | | 95 a | 25 a | 57 a | 0.95 f |
| Jockey Stayer | 2 L/100 kg | 67 b | 4 cd | 15 ef | 1.55 abc |
| Fluopyram 600 FS | 280 mL/100 kg | 67 b | 7 be | 41 be | 1.36 a-e |
| Fluopyram 600 FS | 420 mL/100 kg | 60 b | 4 cd | 21 def | 1.46 a-d |
| Fluopyram 600 FS | 560 mL/100 kg | 63 b | 3 cd | 10 f | 1.39 a-e |

Means followed by the same letter do not significantly differ, Duncan's NMRT (P = 0.05).

### EXAMPLE 2 (SD15AUSSC1)

In Australia, in 2015, trials were conducted with the canola variety ATR Cobbler, which was classed as MS-S (Moderately susceptible to susceptible for bare seed) by the 2012 Australian National Blackleg Rating scheme, sown in a field next to canola stubble in a high rainfall area of the canola growing area of New South Wales, Victoria and Western Australia, to evaluate the efficacy of fluopyram as a seed treatment for the control of blackleg. Fluopyram 600 FS (600 g/L fluopyram) was applied at 140, 280, 420, 500 and 560 mL/100 kg canola seed using a liquid batch seed treater with a slurry volume of 1000 mL/100 kg seed. The resulting application rates were 84 g/100 kg seeds, 168 g/100 kg seeds, 252 g/100 kg seeds, 300 g/100 kg seeds, and 336 g/100 kg seeds. For comparison Jockey Stayer (167 g/L fluquinconazole) was applied, undiluted, at the current registered rate of 2 L/100 kg seed.

TABLE 2
Efficacy of Fluopyram as a seed treatment against Leptosphaeria maculans in canola
(var. ATR Cobbler) (average of 5 trials)

| | | | Leaf | | | |
|---|---|---|---|---|---|---|
| | | | infected | | Stem Area | |
| | | | area | Lodging | Infected | |
| | | | [% control] | [% control] | [% control] | |
| | | | Timepoint | | | |
| | Dosage | Application | 60-72 d | 114-148 d | 114-180 d | |
| | [ml/100 | rate [g/100 | after | after | after | Yield |
| Entry Description | kg seeds] | kg seeds] | planting | planting | planting | (t/ha) |
| Untreated | | | 0 | 0 | 0 | 1.34 |
| Jockey Stayer | 2000 | 334 | 44 | 59 | 34 | 1.48 |
| (fluquinconazole) | | | | | | |
| Fluopyram 600 | 140 | 84 | 48 | 58 | 41 | 1.62 |
| FS | | | | | | |
| Fluopyram 600 | 280 | 168 | 61 | 53 | 36 | 1.63 |
| FS | | | | | | |
| Fluopyram 600 | 420 | 252 | 66 | 69 | 38 | 1.52 |
| FS | | | | | | |
| Fluopyram 600 | 500 | 300 | 63 | 71 | 53 | 1.61 |
| FS | | | | | | |
| Fluopyram 600 | 560 | 336 | 68 | 75 | 49 | 1.47 |
| FS | | | | | | |

### EXAMPLE 3 (SD15AUSSC6)

In Australia, in 2015, trials were conducted with the canola variety ATR Cobbler, which was classed as MS-S (Moderately susceptible to susceptible for bare seed) by the 2012 Australian National Blackleg Rating scheme, sown in a field next to canola stubble in a high rainfall area of the canola growing area of New South Wales, Victoria and Western Australia, to evaluate the efficacy of fluopyram as a seed treatment and in—furrow treatment for the control of blackleg. For seed treatment Fluopyram 600 FS (600 g/L fluopyram) was applied at 140, 280, 420, 500 and 560 mL/100 kg canola seed using a liquid batch seed treater with a slurry volume of 1000 mL/100 kg seed. The resulting application rates were 84 g/100 kg seeds, 168 g/100 kg seeds, 252 g/100 kg seeds, 300 g/100 kg seeds, and 336 g/100 kg seeds. For the in-furrow treatment 10 ml/ha, 20 ml/ha, 30 ml/ha, 40 ml/ha of Fluopyram were used. The resulting application rates were 6 g/ha, 12 g/ha, 18 g/ha and 24 g/ha of Fluopyram. For seed treatment as a comparison Jockey Stayer (167 g/L fluquinconazole) was applied, undiluted, at the current registered rate of 2 L/100 kg seed which corresponds to an application rate of 334 g/100 kg seeds. For in-furrow treatment Intake HiLoad (500 g/L flutriafol) was applied at 200 ml/ha, which corresponds to an application rate of 100 g/ha.

TABLE 3a)
Efficacy of fluopyram as seed treatment against Leptosphaeria maculans in canola
(var. ATR Cobbler) (average of 5 trials)

| | | | Leaf | | | |
|---|---|---|---|---|---|---|
| | | | infected | | Stem Area | |
| | | | area | Lodging | Infected | |
| | | | [% control] | [% control] | [% control] | |
| | | | Timepoint | | | |
| | Dosage | Application | 60-72 d | 115-143 d | 114-180 d | |
| | [ml/100 | rate [g/100 | after | after | after | Yield |
| Entry Description | kg seeds] | kg seeds] | planting | planting | planting | (kg/plot) |
| Untreated | | | 0 | 0 | 0 | 0.36 |
| Jockey Stayer | 2000 | 334 | 61 | 66 | 39 | 0.42 |
| (fluquinconazole) | | | | | | |
| Fluopyram 600 | 280 | 168 | 57 | 68 | 41 | 0.46 |
| FS | | | | | | |
| Fluopyram 600 | 420 | 252 | 82 | 74 | 46 | 0.46 |
| FS | | | | | | |
| Fluopyram 600 | 500 | 300 | 86 | 78 | 45 | 0.52 |
| FS | | | | | | |
| Fluopyram 600 | 560 | 336 | 85 | 79 | 57 | 0.54 |
| FS | | | | | | |

TABLE 3b)
Efficacy of fluopyram as in-furrow treatment against Leptosphaeria maculans in canola
(var. ATR Cobbler) (average of 5 trials)

| | | | Leaf | | | |
|---|---|---|---|---|---|---|
| | | | infected | | Stem Area | |
| | | | area | Lodging | Infected | |
| | | | [% control] | [% control] | [% control] | |
| | | | Timepoint | | | |
| | | | 60-72 d | 114-148 d | 114-180 d | |
| | Dosage | Application | after | after | after | Yield |
| Entry Description | [ml/ha] | rate [g/ha] | planting | planting | planting | (kg/plot) |
| Untreated | | | 0 | 0 | 0 | 0.36 |
| Intake HiLoad | 200 | 100 | 56 | 57 | 42 | 0.45 |
| (flutriafol) | | | | | | |
| Fluopyram 600 | 10 | 6 | 37 | 19 | 20 | 0.25 |
| FS | | | | | | |
| Fluopyram 600 | 20 | 12 | 41 | 24 | 27 | 0.34 |
| FS | | | | | | |
| Fluopyram 600 | 30 | 18 | 60 | 50 | 36 | 0.33 |
| FS | | | | | | |
| Fluopyram 600 | 40 | 24 | 66 | 60 | 43 | 0.43 |
| FS | | | | | | |

1. A product comprising a succinate dehydrogenase inhibitor Fluopyram for control of Leptosphaeria maculans in Brassicaceae plants, plant parts thereof, plant propagation material or the soil in which Brassicaceae plants are grown or intended to be grown.

2. A product according to claim 1, wherein Fluopyram is applied as a seed treatment to Brassicaceae seeds.

3. A product according to claim 1, wherein Fluopyram in said product is capable of being applied as a seed treatment at a rate of 0.1 to 5000 g per 100 kg seeds.

4. A product according to claim 1, wherein the Brassicaceae is Brassica napus.

5. A product according to claim 1, wherein the Brassicaceae is a canola hybrid.

6. A product according to claim 1, wherein Brassicaceae is transgenic.

7. A product according to claim 1, wherein Fluopyram is employed in combination with a further active fungicidal ingredient.

8. Method for controlling Leptosphaeria maculans in Brassicaceae plants, plant parts thereof, plant propagation material or soil in which Brassicaceae plants are grown or intended to be grown, comprising treating the Brassicaceae plants, plant parts thereof, plant propagation material or the soil in which Brassicaceae plants are grown or intended to be grown with Fluopyram.

9. Method according to claim 8, wherein the seeds of Brassicaceae plants are treated at a rate of 0.1 to 5000 g per 100 kg seeds.

10. Method according to claim 8, wherein Leptosphaeria maculans is controlled in Brassicaceae plants at stage 10 or later and wherein the seeds of Brassicaceae plants are treated at BBCH stage 00.

11. Method for increasing yield in Brassicaceae plants, plant parts thereof, plant propagation material or the soil in which Brassicaceae plants are grown or intended to be grown, comprising treating the Brassicaceae plants, plant parts thereof, plant propagation material or the soil in which Brassicaceae plants are grown or intended to be grown with Fluopyram.
